(19) United States
(12) Patent Application Publication
(10) Pub. No.: US 2012/0281779 A1
(43) Pub. Date: Nov. 8, 2012

(54) METHODS AND ENTITIES FOR MODULATION SYMBOL TRANSPORT

(76) Inventor: Bo Göransson, Sollentuna (SE)

(21) Appl. No.: 13/255,322

(22) PCT Filed: May 5, 2011
(86) PCT No.: PCT/EP11/57196

§ 371 Date: Sep. 20, 2011

(51) Int. Cl. H04B 7/02

(52) U.S. Cl. 375/267

(57) ABSTRACT

A method and entity for controlling the transmission and reception of modulation symbols over a communication network capable of MIMO operation is described. The transmission involves generating a block bundle consisting of at least two distinguishable blocks of modulation symbols, wherein each of the at least two distinguishable blocks of the block bundle is configured according to a single set of one or more block configuration parameters, assigning the modulation symbols of each of the at least two distinguishable blocks of the block bundle to distinguishable layers of a corresponding layer bundle for transmitting the modulation symbols, wherein the number of distinguishable layers in the layer bundle is equal to the number of blocks in the block bundle, and transmitting said modulation symbols and signalling only the single set of one or more block configuration parameters for the block bundle. The reception involves the corresponding inverse operation for reconstructing the modulation symbols.

### TECHNICAL FIELD

The present disclosure relates to methods and entities for controlling the transmission or reception of modulation symbols over a communication network capable of MIMO operation.

### BACKGROUND

In wireless communication systems, it is known to process data being sent in such a way that bits are first coded, then modulated according to an appropriate modulation scheme like QPSK (Quadrature Phase Shift Keying) or QAM (Quadrature Amplitude Modulation) for producing modulation symbols, and then appropriately transported via one or more antennas. It is known to map modulation symbols onto a plurality of transportation layers, which are in turn mappable onto physical antennas. The possibility of transporting several distinguishable streams or layers over a plurality of antennas simultaneously is also referred to as Multiple In Multiple Out (MIMO).

Multi-stream transmission or MIMO techniques have been defined both for communication systems employing High Speed Downlink Packet Access (HSDPA) and Long Term Evolution (LTE). In the HSDPA version of Release 7 a dual-stream technique is standardized, while in LTE up to four streams can be multiplexed.

The MIMO schemes defined for LTE and HSDPA are very similar. Data is first coded and modulated and then pre-coded with a matrix (vector) before being transmitted from the physical antennas. In HSDPA closed-loop channel dependent pre-coding is adopted while LTE includes transmission modes both for open- and closed-loop pre-coding.

In both techniques the modulation symbols are grouped into logically distinguishable units or blocks, each unit or block carrying a plurality of symbols. In LTE the blocks can be called codewords and in HSDPA they can be called transport blocks (TB). In the following, the term block will be used as a generic term for any suitable unit of several modulation symbols such as a codeword or TB.

Except for the pre-coding operation the main difference between LTE and HSDPA is the so called block-to-layer mapping. In HSDPA a fixed mapping is used. When a dual-stream transmission occurs, each transport block (TB) is mapped to a layer, hence there is a trivial mapping. In LTE, on the other hand, a maximum of two codewords is scheduled even if e.g. 3 or 4 layer transmission occurs. In this case one codeword is mapped to two layers. FIG. 8 illustrates the case with a transmission referred to as a rank 3 transmission. Here it is assumed that each layer 802 can carry approximately the same amount of data. After codeword-to-layer (CW2L) mapping in element 81 the layers 802 are pre-coded in element 82 and then transmitted from the 4 transmit antennas. Here the second of the codewords 801 is mapped to two of the layers 802, see e.g. 3GPP TS 36.211, Evolved Universal Terrestrial Radio Access (E-UTRA); Physical Channels and Modulation (Release 8) for mappings when other transmission modes are used.

### SUMMARY

An object of the invention lies in providing a mechanism for an efficient enablement of MIMO operation.

According to a first aspect, this object is achieved by a method of controlling the transmission of modulation symbols over a communication network capable of Multiple In Multiple Out, MIMO, operation. The method comprises generating a block bundle consisting of at least two distinguishable blocks of modulation symbols, wherein each of the at least two distinguishable blocks of the block bundle is configured according to a single set of one or more block configuration parameters. The modulation symbols of each of the at least two distinguishable blocks of the block bundle are assigned to distinguishable layers of a corresponding layer bundle for transmitting the modulation symbols, wherein the number of distinguishable layers in the layer bundle is equal to the number of blocks in the block bundle. Said modulation symbols are transmitted and one only signals the single set of one or more block configuration parameters for the block bundle.

According to a second aspect, the above object is achieved by a method of controlling the reception of modulation symbols over a communication network capable of Multiple In Multiple Out, MIMO, operation. The method comprises receiving, over m layer bundles each consisting of a respective number nᵢ of distinguishable layers for transporting modulation symbols, modulation symbols assigned to m block bundles each consisting of a corresponding number nᵢ of distinguishable blocks of modulation symbols. There is a correspondence such that for every block bundle of nᵢ distinguishable blocks there is a corresponding layer bundle of nᵢ distinguishable layers. Furthermore, m is an integer equal to or larger than 1, and nᵢ represents the number of layers in the i-th layer bundle and is an integer larger than 1. One respective set of block configuration parameters for each of said m block bundles is received. Said blocks of modulation symbols of each block bundle are reconstructed using the same respective set of block configuration parameters for each block of the same block bundle, and said reconstructed blocks are passed on for demodulation.

According to a third aspect, the above object is achieved by a network entity for a communication network capable of Multiple In Multiple Out, MIMO, operation. The network entity comprises a generator for generating m block bundles each consisting of a respective number nᵢ of distinguishable blocks of modulation symbols. Each of said m block bundles is such that each distinguishable block of a respective block bundle is configured according to a same single set of one or more block configuration parameters, where m is an integer equal to or larger than 1, nᵢ represents the number of blocks in the i-th block bundle and is an integer larger than 1. The network entity further comprises an assignor for assigning the modulation symbols of each of said block bundles to a corresponding one of m layer bundles. There is a correspondence such that for every block bundle of nᵢ distinguishable blocks there is a corresponding layer bundle of nᵢ distinguishable layers for transporting modulation symbols. Said layers are mappable for MIMO operation. The network entity further comprises a transmitter for transmitting said modulation symbols, and a signaller for signalling only said single respective set of block configuration parameters for each of said block bundles.

According to a fourth aspect, the above object is solved by a network entity for a communication network capable of Multiple In Multiple Out, MIMO, operation. The network entity comprises a symbol receiver for receiving modulation symbols assigned to m block bundles each consisting of a respective number nᵢ of distinguishable blocks of modulation symbols over m layer bundles. Each layer bundle consists of a corresponding number nᵢ of distinguishable layers for transporting modulation symbols, and m is an integer equal to or larger than 1, and nᵢ represents the number of layers in the i-th layer bundle and is an integer larger than 1. There is a correspondence such that for every block bundle of nᵢ distinguishable blocks there is a corresponding layer bundle of nᵢ distinguishable layers. The network entity further comprises a signalling receiver for receiving one respective set of block configuration parameters for each of said m block bundles, and a symbol processor for reconstructing said blocks of modulation symbols of each block bundle using the same respective set of block configuration parameters for each block of the same block bundle, and passing said reconstructed blocks on for demodulation.

According to the first, second, third, and fourth aspect, it is possible to simultaneously schedule at least two distinguishable blocks of modulation symbols in one transmission time interval (TTI), but at the same time only generate signalling overhead for describing the configuration of one of the at least two blocks, as all of the at least two blocks belonging to the block bundle (and hence the layer bundle) are configured the same, i.e. are described by the same set of block configuration parameters. Thus it is possible to expand the number of channels for MIMO without expanding the amount of signalling overhead in equal measure.

### BRIEF DESCRIPTION OF THE DRAWINGS

The present invention will be described in more detail with reference to non-limiting examples shown in the accompanying figures, where

FIG. 1 shows a flow chart of a method of controlling the transmission according to an exemplary embodiment of the first aspect;

FIG. 2 shows a flow chart of a method of controlling the reception according to an exemplary embodiment of the second aspect;

FIG. 3 shows a schematic block diagram of an exemplary embodiment of an entity for transmitting modulation symbols according to the third aspect;

FIG. 4 shows a schematic block diagram of an exemplary embodiment of an entity for receiving modulation symbols according to a fourth aspect;

FIG. 5 shows the mapping of block bundles to corresponding layer bundles;

FIG. 6 shows a schematic example of the mapping of blocks of modulation symbols onto layers for a maximum of 4 layers;

FIG. 7 shows a schematic example of using a layer shifting scheme for the mapping of modulation symbols onto layers; and

FIG. 8 shows a schematic representation of an example of codeword-to-layer mapping in LTE.

FIG. 9 shows an example of the first aspect where 5 layers are transmitted via 8 TX antennas.

FIG. 10 shows an example of the first aspect where 3 block bundles are mapped to 4 layers and then precoded to 6 TX antennas.

FIG. 11 shows block bundle examples when a maximum of 6 layers is supported;

### DETAILED DESCRIPTION

It is herein disclosed a method of controlling the transmission of modulation symbols over a communication network, a method of controlling the reception of modulation symbols over a communication network, a network entity for a communication network comprising a transmitter and a network entity for a communication network comprising a receiver, whereby the communication network is capable of MIMO operation. Those methods and arrangements may, however, be embodied in many different forms and are not to be considered as limited to the embodiments set forth herein; rather, these embodiments are provided so that this disclosure will be thorough and complete.

Still other features and advantages of embodiments of the methods and arrangements may become apparent from the following detailed description considered in conjunction with the accompanying drawings. It is to be understood, however, that the drawings are designed solely for purposes of illustration and not as a definition of the limits of the methods and arrangements. It is further to be understood that the drawings are not necessarily drawn to scale and that, unless otherwise indicated, they are merely intended to conceptually illustrate the structures and procedures described herein.

For example, reference will be made to applying the different aspects to HSDPA, which is a preferred application, but the different aspects can be applied in the context of any MIMO capable system.

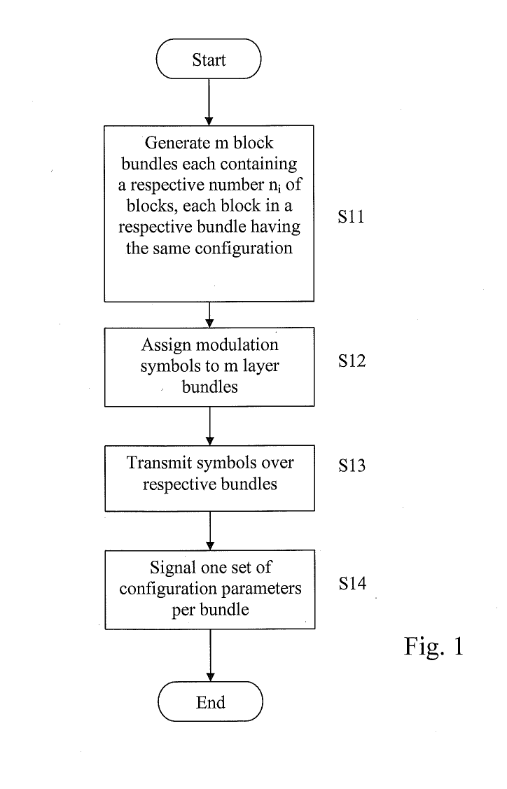

FIG. 1 shows a method embodiment comprising a step S11 of generating m block bundles each consisting of a respective number nᵢ of logically distinguishable blocks of modulation symbols, where each of the m block bundles is such that each distinguishable block of a respective block bundle is configured according to one set of one or more block configuration parameters. The numbers nᵢ and m are integers larger than 1. The modulation can be done in any suitable or desirable way, e.g. can be a QPSK, BPSK or QAM modulation of any desired power, e.g. 2, 4, 16 or 64. The configuration of the blocks and the corresponding parameters for describing the blocks can also be chosen in any suitable or desirable way in connection with the communication system being employed. For example, the set of one or more parameters can comprise one or more of the block size, modulation scheme information, channelization code information, pre-coding information, etc. In step S12 the modulation symbols of each of the m block bundles is assigned to a corresponding one of m layer bundles. Each layer bundle consists of a respective number nᵢ of distinguishable layers for transporting modulation symbols. The layers are mappable for MIMO operation. An example for a distinguishable layer is a layer that can be addressed for mapping individually. In step S13 the modulation symbols are transmitted over the layers, and in step S14 signalling of only one respective set of block configuration parameters for each of the block bundles is performed.

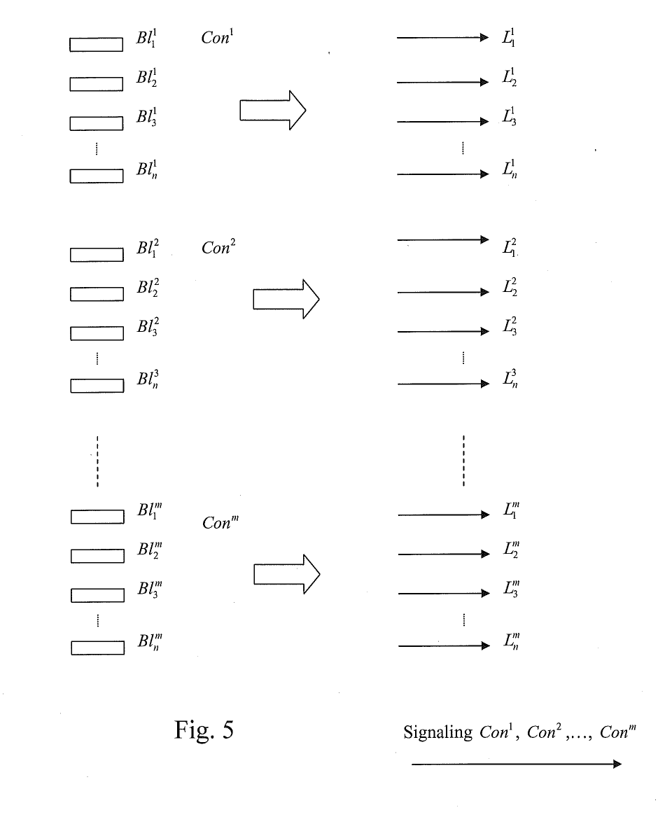

This concept is also shown schematically in FIG. 5. A first bundle of n blocks B₁¹ to Bₙ¹ is characterized by values of a set Con¹ of configuration parameters, i.e. each of the n blocks is the same in terms of the configuration parameters, and this first bundle of blocks is mapped to a corresponding bundle of layers L₁¹ to Lₙ¹. In the same way, a second bundle of n blocks B₁¹ to Bₙ² is characterized by values of a set Con² of configuration parameters and mapped to a corresponding bundle of layers L₁² to Lₙ², and this is done for each of the block bundles up to the m-th. As a result, there are only m sets of configuration parameters Con¹, Con², . . . Con^{m} to be signalled, although m×n blocks are scheduled in one TTI. It is noted that the blocks Bₖ¹ shown in FIG. 5 all appear to have the same size, but the blocks in different bundles may naturally have different sizes. Moreover, while the number nᵢ of blocks of the i-th block bundle is equal to n for all i, and thus the same for all bundles in the schematic example shown in FIG. 5, the invention also allows for the case in which the respective number nᵢ of blocks is not the same for each bundle.

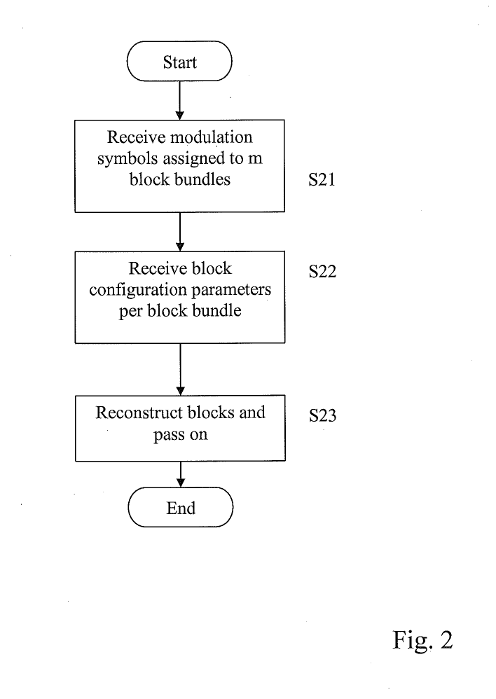

FIG. 2 shows a corresponding method of controlling the receipt of modulation symbols comprising in step S21 receiving modulation symbols assigned to m block bundles each consisting of a respective number nᵢ of distinguishable blocks of modulation symbols over m layer bundles each consisting of a respective number nᵢ of distinguishable layers for transporting modulation symbols. In step S22 one respective set of block configuration parameters for each of said m block bundles is received. The blocks of modulation symbols are reconstructed using said block configuration parameters and passed on for demodulation in step S23.

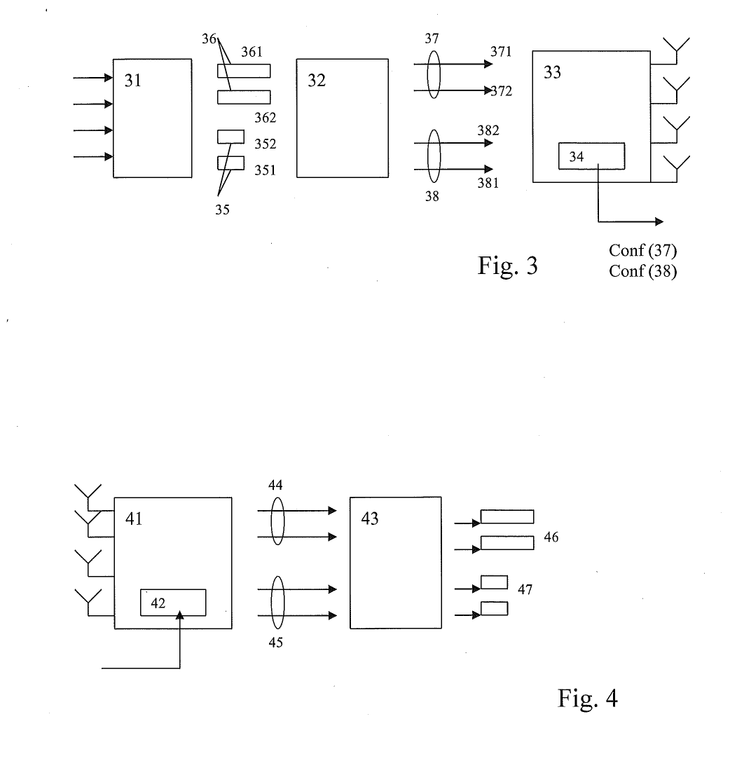

FIG. 3 shows a block diagram of an entity of a communication network that embodies the present invention. It is to be noted that a network entity can be in a physical unit of a network, like a node, or can be spread over a plurality of such physical units. The entity in general comprises a generator 31 for generating m block bundles each consisting of a respective number nᵢ of distinguishable blocks of modulation symbols. In the example, there are two block bundles 35 and 36, each comprising two blocks 351, 352 and 361, 362, respectively. Each of the m block bundles is such that each distinguishable block of a respective block bundle is configured according to one set of one or more block configuration parameters, where m is an integer equal to or larger than 1, and nᵢ represents the number of blocks in the i-th block bundle and is an integer larger than 1. An assignor 32 is provided for assigning the modulation symbols of each of said block bundles 35, 36 to a corresponding one of m layer bundles, shown as 37 and 38 in the example of the figure, each layer bundle consisting of a respective number nᵢ of distinguishable layers for transporting modulation symbols, the layers being mappable for MIMO operation. A transmitter 33 is provided for transmitting said modulation symbols, as well as a signaller 34 for signalling only the one respective set of block configuration parameters for each of the block bundles. In the example Conf(37) describes the configuration parameters of one block of symbols transported over layer bundle 37, and Conf(38) describes the configuration parameters of one block of symbols transported over layer bundle 38. As the two blocks 361 and 362 are identical in configuration (e.g. of identical size), one parameter set for a single block is sufficient for describing both, just the same as one parameter set for one block is sufficient for characterizing the two blocks 351 and 352. Thus, although

$${\sum }_{i = 1}^{m} {n}_{i}$$

blocks are being sent (in the shown example 2+2), it is not necessary to signal configuration information for

$${\sum }_{i = 1}^{m} {n}_{i}$$

blocks, but only for m blocks.

FIG. 4 shows a corresponding entity on the receiving side, comprising a symbol receiver 41 for receiving modulation symbols assigned to m block bundles 44, 45 each consisting of a respective number nᵢ of distinguishable blocks (2 in the shown example) of modulation symbols over m layer bundles each consisting of a respective number nᵢ of distinguishable layers for transporting modulation symbols, where m is an integer equal to or larger than 1, and nᵢ represents the number of blocks in the i-th block bundle and is an integer larger than 1, a signalling receiver 42 for receiving one respective set of block configuration parameters for each of the m block bundles, and a symbol processor 43 for reconstructing said blocks 46, 47 of modulation symbols using said block configuration parameters and passing said reconstructed blocks 46, 47 on for demodulation.

The described methods can also be embodied as a computer program product comprising a computer program arranged for executing the above described methods when loaded into and executed on a programmable network entity of a communication network, or as a computer program comprising computer code parts arranged for executing the above methods when loaded into and executed on a programmable network entity of a communication network. In this connection it is noted that the entities of FIGS. 3 and 4 can be embodied as a mixture of hardware and software, e.g. in such a way that the described elements 31-34 or 41-43 are provided as hardware, software or any suitable combination thereof. For example, the elements can be individual program code parts of a computer program designed to be executed on one or more programmable processors in one or more network nodes.

In accordance with the above, a method of controlling the transmission of modulation symbols over a communication network capable of Multiple In Multiple Out, MIMO, operation is provided, which comprises generating m block bundles, each consisting of a respective number nᵢ of distinguishable blocks of modulation symbols, each of said m block bundles being such that each distinguishable block of a respective block bundle is configured according to a single set of one or more block configuration parameters, where m is an integer equal to or larger than 1, and nᵢ represents the number of blocks in the i-th block bundle and is an integer larger than 1. Then, the modulation symbols of each of said block bundles are assigned to a corresponding one of m layer bundles, there being a correspondence such that for every block bundle of nᵢ distinguishable blocks there is a corresponding layer bundle of nᵢ distinguishable layers for transporting modulation symbols. The layers are mappable for MIMO operation. The modulation symbols are transmitted and one only signals said single respective set of block configuration parameters for each of said block bundles, in order to inform the receiver of the configuration of the blocks being transported, so that the receiver can appropriately reconstruct the blocks and then pass the modulation symbols on for demodulation.

On account of the described concepts, it is possible to simultaneously schedule a number of

$${\sum }_{i = 1}^{m} {n}_{i}$$

blocks of symbols in one transmission time interval (TTI), but at the same time only generate signalling overhead for describing the configuration of m blocks, as all of the blocks belonging to one of the block bundles (and hence layer bundles) are configured the same, i.e. are described by the same set of block configuration parameters. Thus it is possible to expand the number of channels for MIMO without expanding the amount of signalling overhead in equal measure. Furthermore, when expanding an existing system in terms of the number of MIMO channels, it is possible to retain an existing signalling scheme designed for describing a number of individual blocks scheduled simultaneously and to use the signalling scheme for describing an equal number of bundles, each bundle carrying a plurality of blocks or layers, thus providing the additional advantage of not having to make many adjustments in the signalling scheme, if any at all.

When considering an example of mapping 4 blocks simultaneously onto 4 layers (and thus subsequently 4 antennas), the following further advantage of the inventive concept can be discerned. One approach could be to extend the current HSDPA direct mapping of a TB. In this case 4 TBs would be transmitted each TTI. The draw back with such a solution is the associated overhead. The DL control signaling needs to include transmission parameters (e.g. coding and modulation scheme, TB size, . . . ) for all 4 TBs. Similarly, the UL (uplink) control needs to include HARQ (Hybrid Automatic Repeat ReQuest) information for all 4 TBs. Alternatively, the LTE mapping could be used. In this case only a maximum of two TBs would be transmitted each TTI. In this case the DL (downlink) signaling from the known HSDPA MIMO scheme could be reused since it incorporates information for up-to two TBs. Also UL control signaling would be simplified since the current scheme also supports two TBs. The drawback, however, is that new TB sizes need to be defined. Since a TB can be mapped to two layers the maximum size would be twice of that defined today. This would influence the TB size signaling, and redefining the current TB size table is necessary so that the same number of transport block sizes exists, but with a coarser granularity. However, this would lead to worse performance since it will be more difficult to find a suitable TB size matching the current channel conditions. There will also be a larger impact on higher layers. If the maximum TB would be twice of that chosen presently, many parameters in higher layers would need to be redefined, thus leading to problems in introducing the expanded MIMO concept.

The described solutions reduce the drawbacks listed above, but are still able to reuse e.g. signaling channels already defined for a current system, e.g. a system using current HSDPA MIMO. Hence, one can continue to have signalling scheduled for only two TBs in each TTI. Thus, much of the already defined signaling can be reused. On the other hand, the maximum size of a TB can be kept the same as already defined, in order to minimize changes needed in higher layers. The basis of the invention can thus be referred to as “transport block bundling”. Conceptually this can be seen as if two (or more) TBs are bundled together into a “new” unit. Is noted that the generation and transmission of one bundle consisting of two blocks already attains an advantage over the conventional HSDPA MIMO scheme. Namely, by employing such a block bundle, it becomes possible to transmit e.g. three blocks (the block bundle and one single block) during a TTI, while only having to schedule signalling for two blocks. Compared to this, the conventional HSDPA MIMO scheme also requires signalling for two blocks but only achieves the transmission of two blocks during a TTI.

In the following the scheme is described for a four layer MIMO scheme, but as shown above, the general scheme applicable to higher order MIMO as well. To achieve the advantages laid out here, one can consider that such a new unit or codeword (CW) consists of one TB in the case of a single layer while a CW consist of two equal TBs when mapped to two layers. All parameters signalled can then be reused, e.g. when the modulation and coding scheme is signalled this is done per codeword or more specifically per bundle. By definition this then applies for both TB in that codeword. Similarly with TB size where this would indicate the size of one TB related to that codeword, by definition the other TB (if it exist) then has the same size. Also in case of feedback signalling from the receiver to the sender, e.g. HARQ signalling, the parameters (e.g. ACK/NACK and process number) are indicated per CW (i.e. per bundle) meaning that e.g. both TBs associated with a given CW have failed (NACK signalled).

Thus in general the method of FIG. 2 and entity of FIG. 4 are preferably such that sending feedback information sent to a sender of said modulation symbols conveys a receipt state on a per layer bundle basis. In this way, the reverse signalling is also reduced to only m independent pieces of information, despite the transport of

$${\sum }_{i = 1}^{m} {n}_{i}$$

blocks.

Furthermore the method of FIG. 1 and the entity of FIG. 3 are preferably such that feedback information from the receiver of the modulation symbols is received conveying a receipt state on a per block bundle basis.

Now an example is described in more detail on how known control channels in HSDPA can be reused for a 4-layer MIMO scheme using TB bundling. Signaling can be done on the High Speed Shared Control Channel (HS-SCCH). Parameters usable by the terminal to decode MIMO data in the downlink can e.g. be signaled by the HS-SCCH type 3, see e.g. 3GPP TS 25.212, Multiplexing and channel coding (FDD) (Release 7) for details. The HS-SCCH type 3 contains the following information fields:
Channelization code set
Modulation scheme and number of transport blocks (MCS)
Precoding information (PCI)
Transport block size (primary TB)
Transport block size (secondary TB) (for dual stream only)
HARQ process information
Redundancy version (primary TB)
Redundancy version (secondary TB) (for dual stream only)
UE identity

By using TB bundling where two TBs are mapped onto one entity (here called codeword for simplicity), i.e. are assigned to one bundle, one can see that the above can be reused if the two TBs are the same. The only parameters that would be influenced are the MCS and PCI. The MCS can then indicate the modulation for each codeword (both TB belonging to one CW have the same modulation).

Feedback can be sent via the High Speed Dedicated Physical Control Channel (HS-DPCCH). The HS-DPCCH contains feedback from the UE to the NodeB. For MIMO the HS-DPCCH carries HARQ-ACK information as well as CQI/PCI information for single- or dual-stream transmissions. By using TB bundling, the MIMO HS-DPCCH can be reused without modifications if e.g. the following rules are applied: HARQ-ACK signaling applies to bundled TBs and CQI/PCI information relates to bundled TB (codeword) instead of per TB.

For the case, in which the respective number nᵢ of blocks in a block bundle equals n for all i and is thus the same for each block bundle, it is noted that the network entity of FIG. 3 and the method of FIG. 1 can also be provided so that the generator is arranged for generating l block bundles each consisting of k distinguishable blocks of modulation symbols, where 0≦l≦m and 0≦k≦n, and where the assignor is arranged for assigning the modulation symbols of each of said l block bundles to a corresponding one of l layer bundles. In other words, the entity can furthermore also provide and map less than the full number m of block bundles onto corresponding layer bundles. Furthermore, the network entity and method can be such that the assignor is arranged for assigning of the modulation symbols of each of the l block bundles to a corresponding one of said l layer bundles in such a way that all of the modulation symbols belonging to a given one of said k distinguishable blocks are assigned to a corresponding one of k distinguishable layers of the respective layer bundle.

In the case of being able to variably send 0≦l≦m bundles of 0≦k≦n blocks, it is possible that the receiver desires further information for resolving ambiguities.

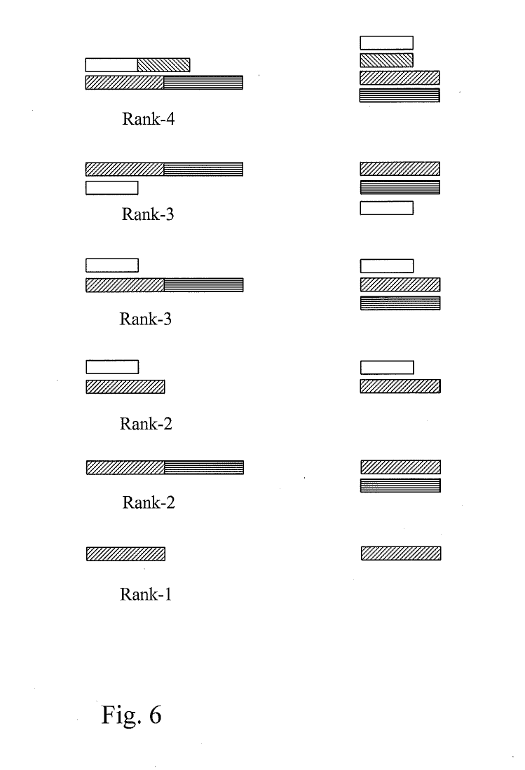

FIG. 6 depicts different alternatives that exist for different so-called ranks. It is seen that a UE (user equipment) can not distinguish between rank-2/3/4 transmissions, similarly it cannot separate a rank-1 from rank-2 (in the case a CW consist of two TB) by using only MCS information. If the MCS indicate two different modulations, it is still not clear if this indicates a rank-2 or rank-4 transmission. To resolve this, it is preferable to introduce specific signaling information addressing this point. For example, a dedicated 3-bit information can be used to distinguish the cases of FIG. 6. However, when adapting an existing system, like e.g. known HSDPA, it is also possible to appropriate existing signaling bits for the new purpose. For example, the PCI bits could be used to indicate the transmission rank. If pilots are pre-coded with the same matrix as data, the UE does not need this information anyway.

While the preceding parts of the description mainly focus on the case with 4 Tx antennas, the idea as such is generally applicable to any number of Tx branches or layers. In the following some example are provided, where the invention is applied to a system with more Tx antennas.

In one example, the invention is applied to a case with 8Tx antennas, e.g., for supporting 8×8 MIMO. In the following, the case is described when two TB bundles are mapped onto layers and transmitted via the precoder on all 8 Tx branches.

This fits the current HSPA standard, since a maximum of two TB is used today.

The disclosed aspects can be employed for both uplink and downlink transmissions. For MIMO uplink transmissions, the generation and transmission of one block bundle is the preferred embodiment. In this way, much of the current signaling in the example of HSDPA can be retained.

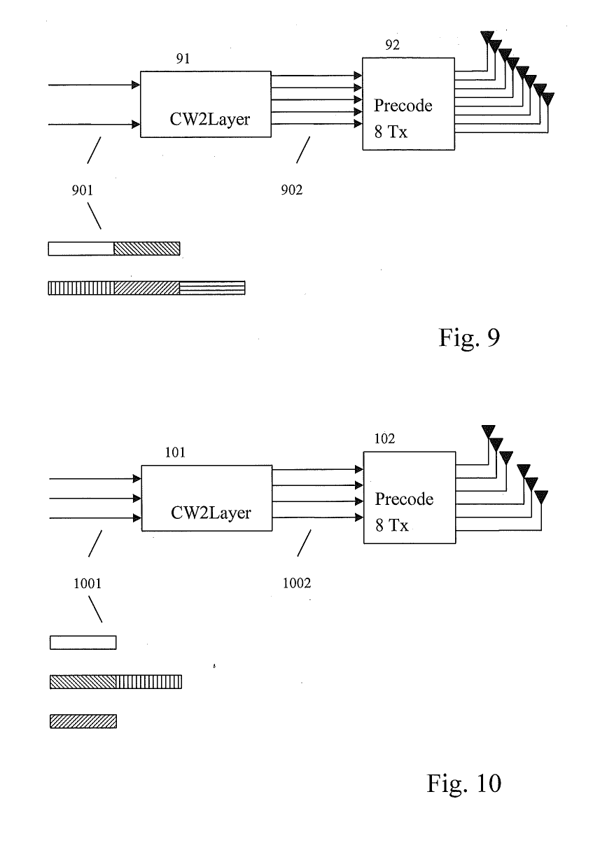

The example shown in FIG. 9 considers the case of 8 Tx antennas. Two TB bundles 901 (here also referred to as codewords, CW) are mapped to five layers 902 by element 91. The layers are then precoded by the precoding element 92 and transmitted over 8 Tx antennas. The first TB bundle consists of two TB while the second bundle consists of three TB.

Yet another example is shown in FIG. 10 where three TB bundles 1001 are mapped to four layers 1002 by element 101, precoded by precoding element 102 and transmitted using 6 Tx antennas. In this particular example, a rank 4 transmission occurs, i.e. the TB bundles 1001 are mapped to 4 layers 1002 before the precoding.

As seen from the above examples, the inventive concept is applicable to any number of Tx antennas supporting any number of codewords and layers. It is noted that the second example is also possible to implement for a system maximum of two codewords (or in this case TB bundles). In this case each bundle could consist of two TB, or one codeword could be a bundle of three TB while the second codeword would consist of a single TB.

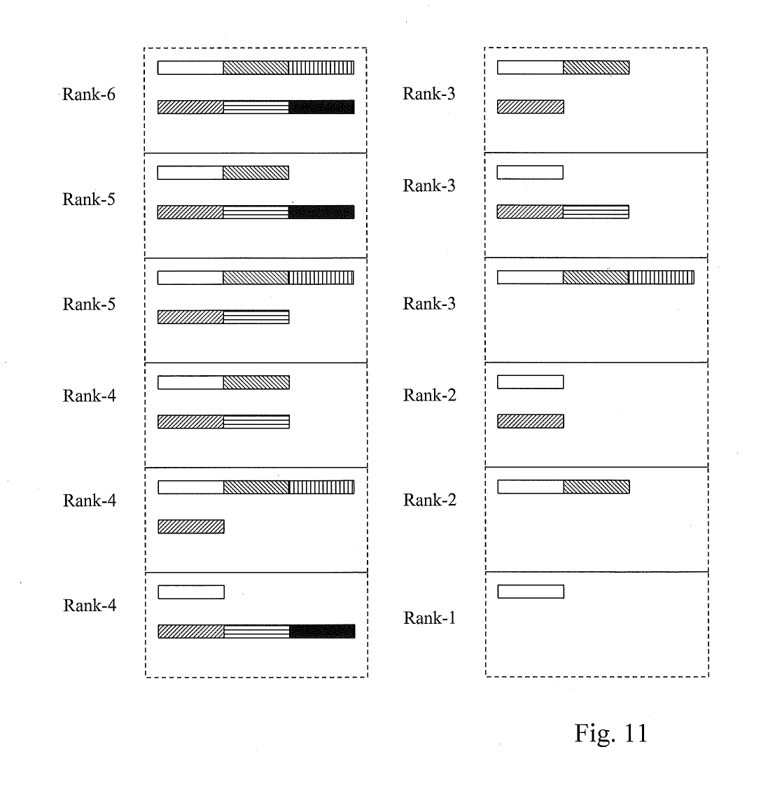

In FIG. 11, an example with 6 Tx antennas is shown, in which up to 6 layers can be transmitted. Still it is assumed that a maximum of two CW are created to fit the signaling of e.g. HSDPA.

It is noted that the “CW2Layer” mapper is not shown in the FIG. 11. In order to signal different mappings, additional signaling bits may be used. It is generally desired to minimize the amount of additional signaling. In order to achieve this, certain mappings (of the 12 possible) can e.g. be invalidated by a rule in the standard. For example, only the lower mapping for rank-5 may be permitted since the layers can be ordered in quality. Thus, the first CW (or bundle) should always contain more (or equal amount) TB than the second CW. Similarly, the number of options for any odd layer (i.e. 3 and 5) can be reduced. Also, in the case of even number of layers only an equal distribution of the TB can be permitted between bundles, hence for rank-4 only the first option is valid.

In addition to the disclosed aspects, it is also possible to generate and transmit one or more single blocks in addition to the generation and transmission of block bundles. This means that not all blocks which are to be transmitted during a TTI need to belong to a block bundle. If, for example, three blocks are to be transmitted during a TTI, one block bundle comprising two blocks can be generated, as well as a single block. Mapping of the blocks to corresponding layers can then be performed for the three blocks. Finally, for transmission, only two sets of configuration parameters need to be signalled—one for the block bundle and one for the single block.

It is noted in this regard that, irrespective of any additional generation and transmission of single blocks during a TTI, an embodiment of the present invention is realized once a block bundle is generated and transmitted in accordance with the subject-matter of the independent claims.

The assigning of modulation symbols to layer bundles can be done in any suitable or desirable way. For example, the assigning of the modulation symbols of each of the block bundles to a corresponding one of the layer bundles can be such that all of the modulation symbols belonging to a given one of said distinguishable blocks are assigned to a corresponding one of the distinguishable layers. In other words, one whole block would be assigned to one associated layer, such that each block of a bundle is sent (per TTI) over one respective layer.

On the other hand, it is also possible to perform the assigning of the modulation symbols of each of said block bundles to a corresponding one of said layer bundles in such a way that the modulation symbols belonging to a given one of the distinguishable blocks are assigned to a plurality of the distinguishable layers according to a layer shifting scheme. This will be explained in more detail in the following.

The current HSDPA MIMO scheme, introduced in Rel-7 of the WCDMA standard, is constrained to two streams (or layers), transmitted from two transmit antennas. Note that in Rel-7 the largest modulation format supported was set to 16QAM, the support for transmission of two 64QAM modulated streams was introduced in a later release. However, the signaling for this was already introduced in Rel-7. This means that all protocols support signaling of transmission parameters for up to two simultaneous transport blocks. Also, the current HSDPA MIMO scheme have a direct mapping of transport blocks to layers, i.e., for a two layer (rank 2) transmission one transport block is mapped to one layer each. This in contrast to the mapping in LTE, where at maximum two transport blocks can be transmitted even in the case of a 3 or 4-layer transmission. In this case one transport block can be mapped to either one or two layers. The mapping rules are fixed and set out in TS 36.211.

One problem with the transport block bundling where all symbols of one block are mapped onto a corresponding layer is that it may not utilize the channel capacity in an optimal way. It is reasonable to assume that each layer will have different qualities (i.e. Signal Noise Ratio SNR) and therefore can support different information data rates. However, the bundling means that both transport blocks in one pair have the same parameters, e.g. modulation order, code rate, number of information bits, etc. Hence to ensure a reasonable probability of error the system needs to adapt the information rate to the layer with lowest SNR. This means that the capacity of the better layer is not fully used.

To overcome the above problem it would be beneficial if the two layers had the same quality (at least in an average sense). By this the same parameters (e.g. MCS) would fit both layers.

The quality of each layer is determined by physical parameters such as fast fading of the radio channel, antenna correlation, interference from other cells, etc. The transmitter can control the mapping between information bits (or modulated symbols) and layers. So, to overcome the problem of unequal layer quality it is possible that, layer shifting (or layer permutation) is used.

In HSDPA each transmission time interval (TTI) of 2 ms consists of 3 slots each with 2560 chips. The spreading factor used in HSDPA is fixed (SF=16), and the rate is determined by the number of such codes scheduled to a certain user. At maximum 15 codes can be scheduled to one user (one code is reserved for pilot and control channels). One slot contains 2560/16=160 symbols and thus one spreading code contain 3*160=480 symbols during one TTI.

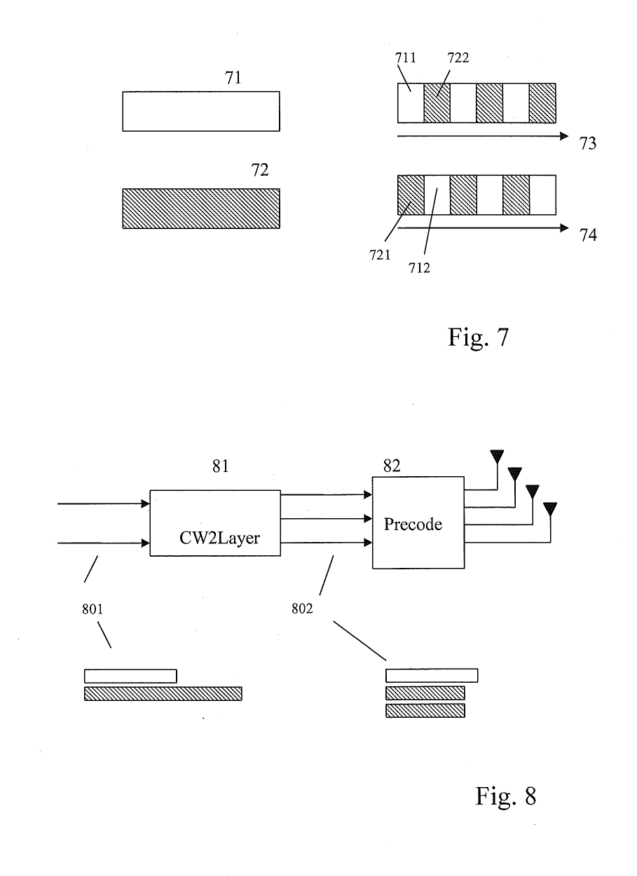

Each transport block will consist of a number of symbols (QPSK, 16QAM or 64QAM). Normally, each transport block and hence corresponding symbols will be mapped to a certain layer, by this all symbols in one layer would experience approximately the same channel quality. If we instead map every second symbol in the first transport block 71 to layer one (73) and vice versa for the second transport block 72, half of the symbols in the first transport block 71 would experience the quality of layer one (73), while the other half would experience the channel of layer two (74), see e.g. symbols 711 and 712 coming from block 71 and symbols 721 and 722 coming from block 72. By this, the average quality of the two streams would be approximately the same. Note that the bits are interleaved and therefore varying quality of the symbols would hit well separated bits and hence the decoder can correct this. The layer shifting (or permutation) is indicated in FIG. 7 where blank and hatched symbols are shifted before being mapped to layers.

The shown layer shifting or mapping scheme is only an example. Other mappings are also possible, for example, x symbols are mapped to layer 1 while the next x symbols are mapped to layer 2, x being an integer larger than 1.

In fact, there are some advantages using x>>1. From a performance point of view one can argue that maximum similarity between layers are obtained if x=1. However, this also increases the complexity of the receiver. This is most noticeable for more advanced receivers based on successive interference cancellation (SIC). In such a receiver, the first stream is detected and then its influence on the second stream is cancelled, hence the quality of the second stream will increase and more bits can be transmitted for a given SNR. If layer shifting is introduced it is noticed that the receiver needs to calculate receiver weights not only for the, say, first layer but also for the second layer when detecting the first symbol stream (transport block). For the case when no layer shifting is used, only weights corresponding to the first layer are needed.

Normally the receiver assumes that the physical channel is stable for a number of symbols, and thus the receiver (say MMSE) weights can be reused for a certain number of symbols. If one chooses layer shifting of a larger set of symbols (say x>10) the increase in complexity would be acceptable. With numbers taken from HSDPA, x=10 or x=16 is a possible choice. This would mean a permutation rate of 16 or 10 per slot. An advantage with layer shifting (permutation) in conjunction with the transport block bundling is that the individual blocks in a bundle experience (on average) similar channel quality. By this it is easier to allocate the same transmission parameters to all blocks in a bundle. Also, the loss in capacity introduced by the bundling is minimized. Although the invention has been described with reference to preferred embodiments, these only serve as illustrations and do not limit the scope of the invention, which is given by the appended claims.

1. A method of controlling the transmission of modulation symbols over a communication network capable of Multiple In Multiple Out, MIMO, operation, the method comprising:
Generating a block bundle comprising at least two distinguishable blocks of modulation symbols, wherein each of the at least two distinguishable blocks of the block bundle is configured according to a single set of one or more block configuration parameters;
Assigning the modulation symbols of each of the at least two distinguishable blocks of the block bundle to distinguishable layers of a corresponding layer bundle for transmitting the modulation symbols, wherein the number of distinguishable layers in the layer bundle is equal to the number of blocks in the block bundle; and
Transmitting said modulation symbols and signaling only the single set of one or more block configuration parameters for the block bundle.

2. The method of claim 1, wherein:
the generating outputs m block bundles, each comprising a respective number nᵢ of distinguishable blocks of modulation symbols, each of said m block bundles being such that each distinguishable block of a respective block bundle is configured according to a single set of one or more block configuration parameters, where m is an integer equal to or larger than 1, and nᵢ represents the number of blocks in the i-th block bundle and is an integer larger than 1;
the modulation symbols of each of said block bundles are assigned to a corresponding one of m layer bundles, there being a correspondence such that for every block bundle of nᵢ distinguishable blocks there is a corresponding layer bundle of nᵢ distinguishable layers for transporting modulation symbols, said layers being mappable for MIMO operation; and wherein
said modulation symbols are transmitted and only said single respective set of block configuration parameters is signalled for each of said block bundles.

3. The method of claim 1, wherein said communication network is arranged for High Speed Downlink Packet Access, HSDPA, and said distinguishable blocks of modulation symbols are transport blocks.

4. The method of claim 3, wherein said signalling is done over a High Speed Shared Control Channel, HS-SCCH.

5. The method of claim 1, further comprising receiving feedback information from a receiver of said modulation symbols, said feedback information conveying a receipt state on a per block bundle basis.

6. The method of claim 1, wherein said assigning of the modulation symbols of a block bundle to a corresponding layer bundle is such that all of the modulation symbols belonging to a given one of said distinguishable blocks are assigned to a corresponding one of said distinguishable layers.

7. The method of claim 1, wherein said assigning of the modulation symbols of a block bundle to a corresponding layer bundle is such that the modulation symbols belonging to a given one of said distinguishable blocks are assigned to a plurality of said distinguishable layers according to a layer shifting scheme.

8. The method of claim 1, wherein m is equal to two.

9. The method of claim 1, wherein nᵢ is equal to two for all values of i.

10. A method of controlling the reception of modulation symbols over a communication network capable of Multiple In Multiple Out, MIMO, operation, the method comprising:
over m layer bundles each comprising a respective number nᵢ of distinguishable layers for transporting modulation symbols, where m is an integer equal to or larger than 1, and nᵢ represents the number of layers in the i-th layer bundle and is an integer larger than 1, receiving modulation symbols assigned to m block bundles each comprising a corresponding number nᵢ of distinguishable blocks of modulation symbols, there being a correspondence such that for every block bundle of nᵢ distinguishable blocks there is a corresponding layer bundle of nᵢ distinguishable layers;
receiving one respective set of block configuration parameters for each of said m block bundles;
reconstructing said blocks of modulation symbols of each block bundle using the same respective set of block configuration parameters for each block of the same block bundle; and
passing said reconstructed blocks on for demodulation.

11. The method of claim 10, further comprising sending feedback information to a sender of said modulation symbols, said feedback information conveying a receipt state on a per block bundle basis.

12. A computer program product comprising a computer program arranged for executing the method of claim 1 when loaded into and executed on a programmable network entity of a communication network.

13. A computer program comprising computer code parts arranged for executing the method of claim 1 when loaded into and executed on a programmable network entity of a communication network.

14. A network entity for a communication network capable of Multiple In Multiple Out, MIMO, operation, comprising:
a generator for generating m block bundles each comprising a respective number nᵢ of distinguishable blocks of modulation symbols, each of said m block bundles being such that each distinguishable block of a respective block bundle is configured according to a same single set of one or more block configuration parameters, where m is an integer equal to or larger than 1, nᵢ represents the number of blocks in the i-th block bundle and is an integer larger than 1;
an assignor for assigning the modulation symbols of each of said block bundles to a corresponding one of m layer bundles, there being a correspondence such that for every block bundle of nᵢ distinguishable blocks there is a corresponding layer bundle of nᵢ distinguishable layers for transporting modulation symbols, said layers being mappable for MIMO operation;
a transmitter for transmitting said modulation symbols; and
a signaller for signalling only said single respective set of block configuration parameters for each of said block bundles.

15. The network entity of claim 14, comprising a base station arranged for High Speed Downlink Packet Access, HSDPA, and where said distinguishable blocks of modulation symbols are transport blocks.

16. A network entity for a communication network capable of Multiple In Multiple Out, MIMO, operation, comprising:
a symbol receiver for receiving modulation symbols assigned to m block bundles each comprising a respective number nᵢ of distinguishable blocks of modulation symbols over m layer bundles each comprising a corresponding number nᵢ of distinguishable layers for transporting modulation symbols, where m is an integer equal to or larger than 1, and nᵢ represents the number of layers in the i-th layer bundle and is an integer larger than 1, there being a correspondence such that for every block bundle of nᵢ distinguishable blocks there is a corresponding layer bundle of nᵢ distinguishable layers;
a signalling receiver for receiving one respective set of block configuration parameters for each of said m block bundles; and
a symbol processor for reconstructing said blocks of modulation symbols of each block bundle using the same respective set of block configuration parameters for each block of the same block bundle, and passing said reconstructed blocks on for demodulation.

17. The method of claim 1, wherein:
the block bundle that is generated consists of the at least two distinguishable blocks of modulation symbols, wherein each of the at least two distinguishable blocks of the block bundle is configured according to the single set of one or more block configuration parameters.

18. The method of claim 10, wherein:
the m layer bundles each consist of the respective number nᵢ of distinguishable layers for transporting modulation symbols; and
the received modulation symbols assigned to m block bundles each consist of the corresponding number nᵢ of distinguishable blocks of modulation symbols.

19. The network entity of claim 14, wherein:
the m block bundles that are generated by the generator each consist of the respective number nᵢ of distinguishable blocks of modulation symbols.

20. The network entity of claim 16, wherein:
the symbol receiver receives the modulation symbols assigned to the m block bundles each consisting of the respective number nᵢ of distinguishable blocks of modulation symbols over m layer bundles each consisting of the corresponding number nᵢ of distinguishable layers for transporting modulation symbols.
